(19) United States
(12) Patent Application Publication
(10) Pub. No.: US 2011/0169608 A1
(43) Pub. Date: Jul. 14, 2011

(54) METHOD OF OPERATING AN RFID READER IN AN RFID SYSTEM

(76) Inventors: Matthew R. LaFontaine, Fort Wayne, IN (US); Court H. Sailor, Spencerville, IN (US)

(21) Appl. No.: 12/945,221

(22) Filed: Nov. 12, 2010

Related U.S. Application Data
(60) Provisional application No. 61/260,986, filed on Nov. 13, 2009.

(51) Int. Cl. G06K 7/01

(52) U.S. Cl. 340/10.1

(57) ABSTRACT

A method of operating a Radio Frequency Identification (RFID) reader used in an RFID system for use with a device includes the steps of: providing that the RFID system includes the RFID reader and an RFID tag, the RFID tag being attached to the device; controlling dynamically the RFID reader; monitoring constantly a plurality of outputs of the RFID reader; and determining, dependent on the steps of controlling and monitoring, whether the RFID reader senses the RFID tag in an actual location of the RFID tag.

### CROSS REFERENCE TO RELATED APPLICATIONS

This is a non-provisional application based upon U.S. provisional patent application Ser. No. 61/260,986, entitled “METHOD OF OPERATING AN RFID READER IN AN RFID SYSTEM”, filed Nov. 13, 2009, which is incorporated herein by reference.

### BACKGROUND OF THE INVENTION

1. Field of the Invention

The present invention relates to RFID systems for use with device logistics (such as, but not limited to, medical equipment), and, more particularly, to methods of operating RFID readers used in such systems.

2. Description of the Related Art

Radio frequency identification (RFID) tags are well known throughout industry, and are being increasingly utilized for supply chain management, inventory management, and logistic control. These tags can be written to and read from a handheld transceiver or fixed portal. Small low frequency tags are currently being utilized in surgical tools and implantable devices.

What is needed in the art is a method to determine, using an RFID reader, when a device including an RFID tag is likely located in a desired read zone.

### SUMMARY OF THE INVENTION

The present invention provides a method to determine, using an RFID reader, when a device including an RFID tag is likely located in a desired read zone.

The invention in one form is directed to a method of operating a Radio Frequency Identification (RFID) reader used in an RFID system for use with a device. The method includes the steps of: providing that the RFID system includes the RFID reader and an RFID tag, the RFID tag being attached to the device; controlling dynamically the RFID reader; monitoring constantly a plurality of outputs of the RFID reader; and determining, dependent on the steps of controlling and monitoring, whether the RFID reader senses the RFID tag in an actual location of the RFID tag.

The invention in another form is directed to a locating system including a device and a Radio Frequency Identification (RFID) system including an RFID reader and an RFID tag. The RFID tag is attached to the device. The RFID reader is configured for providing a plurality of outputs, for being controlled dynamically, for monitoring constantly the plurality of outputs of the RFID reader, and for thereby determining whether the RFID reader senses the RFID tag in an actual location of the RFID tag.

An advantage of the present invention is that it lessens missed reads, such as when RFID tags are so close to a carbon fiber treatment table that the RFID reader may not sense the presence of the RFID tag on the carbon fiber treatment table.

Another advantage of the present invention is that it lessens extra reads, such as when RFID tags which are not on the treatment table (i.e., by way of a medical device which includes the RFID tag) are sometimes sensed by the RFID reader.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a table illustrating different operating parameters associated with a reader operating according to the method of the present invention, under nine different operating conditions; and

FIG. 2 is a simplified illustration of the nine different operating conditions assumed in FIG. 1.

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

Referring now to the drawings, there is shown schematically a locating system 10 which generally includes a device 12 and a Radio Frequency Identification (RFID) system 14. RFID system 14 includes an RFID reader 16 and an RFID tag 18. RFID tag 18 is attached to device 12.

The description below describes the present invention with reference to a specific environment. However, it is understood that the present invention applies just as well to other environments. Stated another way, the present invention applies to a range of scenarios and is not limited to the RF (radio frequency) suite application. For instance, the description below uses the following terminology: medical device 12; treatment table 20 (such as a carbon fiber treatment table 20); carbon fiber; a radiation oncology device; medical patient; patient; treatment vault; and table. It is understood that this terminology is not to be considered limiting, but is used merely by way of example. Thus, the present invention applies to devices, not only to medical devices 12 or to radiation oncology devices; thus, reference number 12 also applies to devices generally. Further, the present invention applies to a desired read zone (the zone which it is desired that RFID reader 16 reads), not only to a table, or a treatment table 20, or a carbon fiber treatment table 20; thus, reference number 20 also applies to a desired read zone. Further, the present invention applies to an RF-reflecting environment (radio frequency reflecting environment) and also to an RF-absorbing environment (radio frequency absorbing environment), not only to a carbon fiber environment (as with carbon fiber treatment table 20); thus, the reference number 20 can also apply not just to a desired read zone but also to a desired read zone having an RF-reflecting environment or an RF-absorbing environment. Thus, the present invention can also apply to a desired read zone 20 including a ferrous environment or generally a metallic environment (i.e., metallic objects). Further, the present invention applies to persons generally (in a variety of contexts), not only to patients or medical patients. Further, the present invention applies to environments generally (to a variety of environments), not only to treatment vaults.

It has been found that, when reading RFID tags on a radiation oncology device in a treatment vault using conventional RFID readers, the following problems may occur: (1) tags which are too close to the carbon fiber treatment table are sometimes not read; and (2) tags which are not on the treatment table are sometimes read. Traditionally, the reader power and sensitivity are set at medium levels to capture a large number of difficult reads, while not creating so much stray RF (radio frequency) as to read tags not on the table. This static, medium setting is a compromise, which may lead to missed reads and extra reads.

By contrast, in summary, the present invention uses dynamic control of RFID reader 16 and constant monitoring of the output to more successfully determine whether RFID tag 18 is seen in its actual location. Basically, RFID reader 16 power and sensitivity settings oscillate from high to low output and the number of reads are counted. At high power, RFID reader 16 will see everything on the treatment table 20 (such as the carbon fiber treatment table 20 mentioned above), including RFID tags 18 very close to the carbon fiber treatment table 20. Unfortunately, RFID reader 16 will also see items not on table 20. To filter these unwanted reads out of the data set, the power of RFID reader 16 will then be set to medium. At medium power, even RFID tags 18 too close to carbon fiber table 20 will be seen more than items (such as medical device 12 with an RFID tag 18) off carbon fiber treatment table 20. These readings would be added to the data set. At low power, the items (a medical device 12 with an RFID tag 18) not on the table 20 will disappear from the reader 16. It can then be inferred that these items 12, 18 were not on carbon fiber treatment table 20.

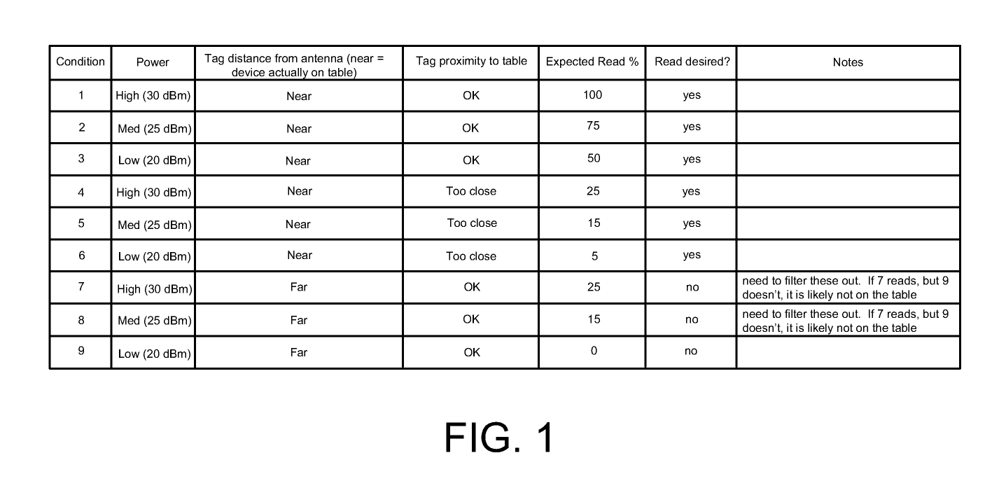

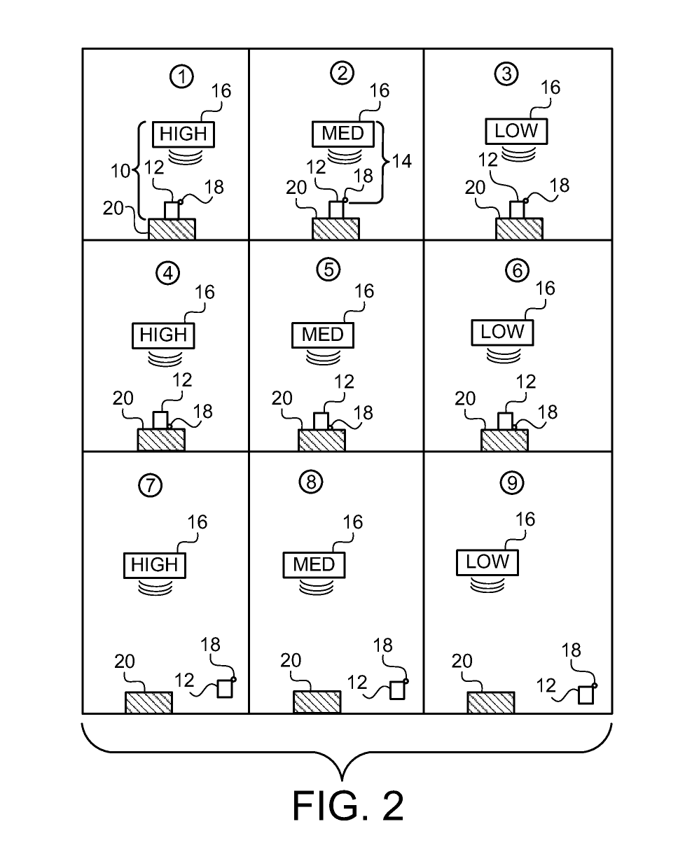

RFID reader 16 of the present invention is configured for providing a plurality of outputs, is configured for being controlled dynamically, is configured for monitoring constantly the outputs of RFID reader 16, and is thereby configured for determining whether RFID reader 16 senses RFID tag 18 in an actual location of RFID tag 18. Stated another way, RFID reader 16 of the present invention is configured for determining whether RFID tag 18 (and thus also medical device 12 to which RFID tag 18 is attached) is actually located on carbon fiber treatment table 20 or is not actually located on carbon fiber treatment table 20. In making this determination (whether RFID tag 18 is or is not actually on carbon fiber treatment table 20), RFID reader 16 is configured for oscillating the power setting of RFID reader 16 between high power, medium power, and low power of RFID reader 16. In oscillating between high power, medium power, and low power, RFID reader 16 takes at least three reads. RFID reader 16 is configured for counting and thus tracking a plurality of reads. These plurality of reads include a first read, a second read, and a third read, the first read occurring at high power of RFID reader 16, the second read occurring at medium power of RFID reader 16, and third read occurring at low power of RFID reader 16. Each one of the outputs of RFID reader 16 corresponds to a respective one of the reads. In other words, each read (one occurring at high power, one read occurring at medium power, and one read occurring at low power) produces an output, each output of each read including (a) RFID tag 18 is sensed by RFID reader 16, or (b) RFID tag 18 is not sensed by RFID reader 16. Each of these outputs from the reads is used by RFID reader 16 to determine whether or not RFID tag 18 (and thus also medical device 12 to which RFID tag 18 is attached) is actually located on carbon fiber treatment table 20. Thus, RFID reader 16 is configured for evaluating each of the plurality of outputs from the plurality of reads and thereby for filtering out when medical device 12 along with its RFID tag 18 are not actually located on carbon fiber treatment table 20 so as to determine that medical device 12 along with its RFID tag 18 are likely on carbon fiber treatment table 20 only when medical device 12 along with its RFID tag 18 are actually on carbon fiber treatment table 20. The operation of RFID reader 16 in connection with medical device 12, RFID tag 18, and carbon fiber treatment table 20 is shown in FIGS. 1 and 2 and further explained below.

The present invention further provides a method of operating a RFID reader 16 used in RFID system 14 for use with medical device 12, the method including the steps of: providing that RFID system 14 includes RFID reader 16 and an RFID tag 18, RFID tag 18 being attached to medical device 12; controlling dynamically RFID reader 16; monitoring constantly a plurality of outputs of RFID reader 16; and determining, dependent on the steps of controlling and monitoring, whether RFID reader 16 senses RFID tag 18 in an actual location of RFID tag 18. The step of controlling includes oscillating a power setting of RFID reader 16 between a high power, a medium power, and a low power. The step of controlling includes counting a plurality of reads. The plurality of reads includes a first read, a second read, and a third read, the first read occurring at high power, the second read occurring at medium power, and the third read occurring at low power. Each one of the plurality of outputs corresponds to a respective one of the plurality of reads, each output of each read including (a) RFID tag 18 is sensed by RFID reader 16, or (b) RFID tag 18 is not sensed by RFID reader 16. The step of determining includes evaluating each of the plurality of outputs from the plurality of reads and thereby filtering out when medical device 12 along with its RFID tag 18 are not actually located on carbon fiber treatment table 20 so as to determine that medical device 12 along with its RFID tag 18 are likely on carbon fiber treatment table 20 only when medical device 12 along with its RFID tag 18 are actually on carbon fiber treatment table 20.

FIG. 1 provides a table of data, while FIG. 2 illustrates each of the conditions 1-9 shown in FIG. 1. FIG. 1 shows the condition number in the first column (reading from left to right) of the table of FIG. 1. Block 1 in FIG. 2 corresponds to the first row of FIG. 1 and thus shows condition 1. Similarly, blocks 2-9 in FIG. 2 correspond respectively the second through the ninth rows of FIG. 1 and thus show conditions 2-9 of FIG. 1. Each condition 1-9 corresponds respectively to a single read executed by RFID reader 16. The second column of the table of FIG. 1 provides the power setting of RFID reader 16, the power setting being high power, medium power, or low power (as discussed above). As shown in FIG. 1, high power can correspond to 30 dBm (decibel milliwatt, which refers to the power ratio in decibels of the measured power referenced to one milliwatt)(as shown in FIG. 1 relative to conditions 1, 4, and 7); medium power can correspond to 25 dBm (as shown in FIG. 1 relative to conditions 2, 5, and 8); and low power can correspond to 20 dBm (as shown in FIG. 1 relative to conditions 3, 6, and 9). The third column of the table of FIG. 1 provides the distance between RFID tag 18 and RFID reader 16 (the top row of the third column of the table of FIG. 1 refers to RFID reader 16 as the “antenna”). As explained in the top row of the first column of FIG. 1, the entry “near” means that medical device 12 (to which RFID tag 18 is attached) is actually located on treatment table 20; conversely, the entry “far” in the third column means that medical device 12 (to which RFID tag 18 is attached) is not actually located on treatment table 20. The fourth column of the table of FIG. 1 provides information as to the proximity of RFID tag 18 to treatment table 20. The entry “OK” means that the distance between RFID tag 18 and treatment table 20 is such that the treatment table 20 (such as, more specifically, the material of treatment table 20) effectively does not cause RFID reader 16 not to read RFID tag 18 of medical device 12. Conversely, the entry “too close” means that the distance between RFID tag 18 and treatment table 20 is so close such that the treatment table 20 does cause RFID reader 16 not to read RFID tag 18 of medical device 12. The fifth column of FIG. 1 provides the percentage or chance that RFID reader 16 will read (that is, sense) RFID tag 18 under the given circumstances. The sixth column of FIG. 1 provides whether it is desired that RFID reader 16 reads (senses) RFID tag 18. Thus, a “yes” entry means that it is desired that RFID reader 16 sense RFID tag 18; conversely, a “no” entry means that it is desired that RFID reader 16 does not sense RFID tag 18.

Conditions 1-3 of FIGS. 1 and 2 provide that RFID tag 18 is located on or in medical device 12 (which can be, for example, a radiation oncology device), that medical device 12 is located on carbon fiber treatment table 20, that RFID tag 18 is distanced from treatment table 20 such that RFID reader 16 is expected to be able to read (sense) RFID tag 18. Conditions 1, 2, and 3 provide that the power of RFID reader 16 is set at high, medium, and low, respectively. Further, because medical device 12 and thus also its associated RFID tag 18 are located on treatment table 20, it is desired that RFID reader 16 sense RFID tag 18.

Conditions 4-6 of FIGS. 1 and 2 provide that RFID tag 18 is located on or in medical device 12, that medical device 2 is located on carbon fiber treatment table 20, and that RFID tag 18 is too close to treatment table 20 (as explained above). Conditions 4, 5, and 6 provide that the power of RFID reader 16 is set at high, medium, and low, respectively. Because RFID tag 18 is too close to treatment table 20, the expected read percentages of conditions 4, 5, and 6 are lower relative to the expected read percentages in conditions 1, 2, and 3. Further, because medical device 12 and thus also its associated RFID tag 18 are located on treatment table 20, it is desired that RFID reader 16 sense RFID tag 18.

Conditions 7-9 of FIGS. 1 and 2 provide that RFID tag 18 is located on or in medical device 12, that medical device 12 is not located on carbon fiber treatment table 20, and that RFID tag 18 is distanced from treatment table 20 such that RFID reader 16 is expected to be able to read (sense) RFID tag 18. Conditions 7, 8, and 9 provide that the power of RFID reader 16 is set at high, medium, and low, respectively. Because medical device 12 and its associated RFID tag 18 is not located on treatment table 20, the expected read percentages of conditions 7, 8, and 9 are lower relative to the expected read percentages in conditions 1, 2, and 3. Further, because medical device 12 and its associated RFID tag 18 are not located on treatment table 20, it is not desired that RFID reader 16 sense RFID tag 18. It is desired that only those medical devices 12 and associated RFID tags 18 which are located on treatment table 20 be read (sensed) by RFID reader 16.

In use, a medical patient can be placed on treatment table 20. RFID reader 16 can then be used to sense whether or not an RFID tag 18 (attached to a medical device 12) is present relative to patient. To make this determination, RFID reader 16 takes a plurality of readings at different power settings, as discussed above. FIGS. 1 and 2 each show three separate runs of the process according to the present invention. Conditions 1-3 correspond to the first run. Conditions 4-6 correspond to the second run. Conditions 7-9 correspond to the third run. Similarly, the first row of blocks in FIG. 2 (that is, blocks 1-3) corresponds to the first run; the second row of blocks in FIG. 2 (that is, blocks 4-6) corresponds to the second run; and the third row of blocks in FIG. 2 (that is, blocks 7-9) corresponds to the third run. FIGS. 1 and 2 show that each run includes a plurality of readings of RFID reader 16, the power of RFID reader 16 oscillating between high, medium, and lower power settings (the power of RFID reader 16 can be reflective of the sensitivity of RFID reader 16). Each reading provides an output as to whether RFID reader 16 senses an RFID tag 18. Standing alone, a single reading of RFID reader 16 may be inaccurate, as explained above. However, by oscillating the power of RFID reader 16 between high, medium, and low, RFID reader 16 can include an algorithm which evaluates the readings together and thereby make a more accurate determination as to whether medical device 12 and its associated RFID tag 18 is actually located (which can mean indirectly by way of the patient's body) on treatment table 20. The evaluation of the readings per run to determine whether the medical device 12 and its associated RFID tag 18 are actually located on treatment table 20 can be performed automatically by RFID reader 16 or a controller associated with RFID reader 16, or can be performed manually by the operator of RFID reader 16. Thus, known information for making the determination as to whether medical device 12 and its associated RFID tag 18 is actually located on treatment table 20 can include a count of the read iteration, the power setting, and whether RFID reader 16 sensed RFID tag 18. This information then can be used to determine whether medical device 12 and its associated RFID tag 18 are actually located on treatment table 20. For instance, in the first and second runs (conditions 1-3 and 4-6, respectively), if RFID reader 16 senses RFID tag 18 during each reading, then one can reasonably determine that medical device 12 and its associated RFID tag 18 are actually located on treatment table 20. However, if as in the third run RFID reader 16 does not sense RFID tag 18 during any reading, then this indicates that that medical device 12 and its associated RFID tag 18 may not actually be located on treatment table 20. While each run in FIGS. 1 and 2 is shown as including three readings, more readings can be included in a respective run to enhance accuracy of the determination that medical device 12 and its associated RFID tag 18 are or are not actually located on treatment table; that is, more readings can improve accuracy of the determination. RFID reader 16 (or a controller controlling RFID reader 16) can be programmed to perform a predetermined number of readings (i.e., three, four, ten, fifty, etc.) at two, three, or more power settings before proceeding to evaluate each of the readings (more specifically, the outputs of the readings) and making a determination whether medical device 12 and its associated RFID tag 18 are actually located on treatment table 20.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of operating a Radio Frequency Identification (RFID) reader used in an RFID system for use with a device, said method comprising the steps of:
providing that the RFID system includes the RFID reader and an RFID tag, said RFID tag being attached to the device;
controlling dynamically the RFID reader;
monitoring constantly a plurality of outputs of the RFID reader; and
determining, dependent on said steps of controlling and monitoring, whether the RFID reader senses said RFID tag in an actual location of said RFID tag.

2. The method of operating according to claim 1, wherein the step of controlling includes oscillating a power setting of the RFID reader between a high power, a medium power, and a low power.

3. The method of operating according to claim 2, wherein the step of controlling includes counting a plurality of reads.

4. The method of operating according to claim 3, wherein said plurality of reads includes a first read, a second read, and a third read, said first read occurring at said high power, said second read occurring at said medium power, and said third read occurring at said low power.

5. The method of operating according to claim 4, wherein each one of said plurality of outputs corresponds to a respective one of said plurality of reads, each said output of each said read including one of (a) said RFID tag is sensed by the RFID reader, and (b) said RFID tag is not sensed by the RFID reader.

6. The method of operating according to claim 5, wherein said step of determining includes evaluating each of said plurality of outputs from said plurality of reads and thereby filtering out when the device along with said RFID tag are not actually located in a desired read zone so as to determine that the device along with said RFID tag are likely in said desired read zone only when the device along with said RFID tag are actually in said desired read zone.

7. A locating system, comprising:
a device;
a Radio Frequency Identification (RFID) system including an RFID reader and an RFID tag, said RFID tag being attached to said device, said RFID reader configured for providing a plurality of outputs, for being controlled dynamically, for monitoring constantly said plurality of outputs of said RFID reader, and for thereby determining whether said RFID reader senses said RFID tag in an actual location of said RFID tag.

8. The locating system according to claim 7, wherein said RFID reader is configured for oscillating a power setting of said RFID reader between a high power, a medium power, and a low power.

9. The locating system according to claim 8, wherein said RFID reader is configured for counting a plurality of reads.

10. The locating system according to claim 9, wherein said plurality of reads includes a first read, a second read, and a third read, said first read occurring at said high power, said second read occurring at said medium power, and said third read occurring at said low power.

11. The locating system according to claim 10, wherein each one of said plurality of outputs corresponds to a respective one of said plurality of reads, each said output of each said read including one of (a) said RFID tag is sensed by said RFID reader and (b) said RFID tag is not sensed by said RFID reader.

12. The locating system according to claim 11, wherein said RFID reader is configured for evaluating each of said plurality of outputs from said plurality of reads and thereby for filtering out when said device along with said RFID tag are not actually located in a desired read zone so as to determine that said device along with said RFID tag are likely in said desired read zone only when said device along with said RFID tag are actually in said desired read zone.
